(19) United States
(12) Patent Application Publication
(10) Pub. No.: US 2022/0417659 A1
(43) Pub. Date: Dec. 29, 2022

(54) SYSTEMS, METHODS, AND DEVICES FOR AUDIO CORRECTION

(71) Applicant: Comcast Cable Communications, LLC, Philadelphia, PA (US)

(72) Inventors: Ganesh Narayanan, NEED (US); Scott Kurtz, Mount Laurel, NJ (US)

(21) Appl. No.: 17/304,564

(22) Filed: Jun. 23, 2021

(51) Int. Cl. H04R 3/12; G10L 21/0216

(52) U.S. Cl. CPC H04R 3/12; G10L 21/0216; G10L 2021/02087

(57) ABSTRACT

Systems, methods, and devices relating to audio correction are described. A first portion of content including first spoken audio content indicating first word(s) may be determined. Background audio content of the first portion of the content may be determined. A voice profile may be determined based on the first spoken audio content. Based on the voice profile, second spoken audio content indicating second word(s) to replace the first word(s) may be generated. Based on mixing the background audio content and the second spoken audio content, a second portion of content may be determined. In the content, the first portion of the content may be replaced with the generated second portion of content.

### BACKGROUND

It is commonplace for audio/video content to include a person speaking live, on a short time delay, or otherwise “on the fly,” such as a news anchor, newsreader, front line reporter, sportscaster, talk show host, or the like. In these and similar circumstances, the speaker may sometimes unintentionally say an incorrect word or mispronounce what would otherwise be a correct word. However, there may be little opportunity in these cases for the speaker to perform a second take using the correct word or pronunciation. In addition to the challenges inherent in fixing an incorrect word in audio/video content, there may be little opportunity for manual review when the audio/video content is live or on a short time delay. Manual review and editing may also be excessively time consuming, particularly where there are numerous instances of incorrect words.

These and other shortcomings are addressed in the present disclosure.

### SUMMARY

Systems, methods, and devices relating to audio correction are described herein.

Audio correction may be applied to content, such as a news program, a sports broadcast, a game show, or a talk show, to automatically identify any “incorrect” words spoken by a featured speaker in the content and correct those words by replacing them with appropriate “correct” spoken words in the content. The audio correction may be performed in real time. The correct spoken words may be generated (e.g., as spoken audio content) based on a voice profile associated with the speaker. The voice profile may be generally representative of the speaker's manner of speech. To this end, the voice profile may indicate various characteristics of the speaker's speech, such as audio, vocal, and/or linguistic characteristics of his or her speech. By using the speaker's voice profile to generate the correct spoken words, the correct spoken words may be perceived by viewers as if they were actually said by the speaker. (As used herein, “spoken” or similar terms shall refer to speech from a human and/or computer-generated speech, such as the generated correct spoken words here.) To facilitate audio correction, the speaker's speech (including any incorrect spoken words) in the content may be separated out or isolated from the background audio in the content. Additionally or alternatively, a white noise effect may be applied over portions of the audio spectrum occupied by the speech. In this manner, the correct spoken words may be separately generated and later mixed with the corresponding background audio to determine corrected content. In addition, the voice profile associated with the speaker may be updated on an on-going basis as the content is processed for audio correction.

In a method, a first portion of content comprising first spoken audio content indicating first one or more words may be determined. The first one or more words may be incorrect words, for example. Background audio content of the first portion of the content may be determined. Second spoken audio content indicating second one or more words to replace the first one or more words may be generated. The second spoken audio content may be generated based on a voice profile associated with the first spoken audio content (e.g., associated with the speaker of the first one or more words). The second one or more words may be correct words associated with the first one or more (incorrect) words, for example. The background audio content and the second spoken audio content may be mixed. Based on this mixing, a second portion of content may be generated. The second portion of content may comprise the background audio content and the second spoken audio content indicating the second one or more (correct) words. The first portion of the content may be replaced with the second portion of content.

In a method, a portion of content comprising background audio content and first spoken audio content indicating first one or more words may be determined. The first one or more words may be incorrect words, for example. The first spoken audio content may be removed from the portion of the content, such as via a white noise effect. Second spoken audio content indicating second one or more words associated with the first one or more words may be generated. The second spoken audio content may be determined based on a voice profile. The voice profile may have been determined based on the first spoken audio content. The voice profile may be associated with the first one or more words' speaker. The second one or more words may be correct words associated with the first one or more (incorrect) words, for example. The second spoken audio content may be mixed with the background audio content. The resultant content may comprise a corrected portion of the content.

In a method, one or more incorrect spoken words in a portion of content may be determined. One or more correct spoken words may be determined to replace the one or more incorrect spoken words in the portion of the content. The one or more correct spoken words may be determined based on a voice profile. The voice profile may have been determined based on the one or more incorrect spoken words. The voice profile may be associated with the incorrect spoken words' speaker. The one or more incorrect spoken words may be removed from the portion of the content. The one or more correct spoken words may be mixed with background audio in the portion of the content. The resultant mix may comprise a corrected portion of the content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 shows an example system.

FIG. 2 shows example audio/video content subject to audio correction.

FIG. 3 shows example audio/video content subject to audio correction.

FIG. 4 shows an example block diagram.

FIG. 5 shows an example method.

FIG. 6 shows an example computing device.

Aspects of the disclosure will now be described in detail with reference to the drawings, wherein like reference numbers refer to like elements throughout, unless specified otherwise.

### DETAILED DESCRIPTION

Systems, methods, and devices relating to audio correction are described. The audio correction techniques described herein may be employed to identify and correct any incorrect words (e.g., incorrect with respect to meaning, pronunciation, and/or grammar, or otherwise determined to be replaced) spoken in content, such as a television news program, a talk show, a game show, or a sports broadcast. As suggested, these techniques may be particularly apt in scenarios where a speaker directly addresses the camera, which is often live or on only a short time delay and without an explicit script for the speaker to follow. Even when reading from a script or a teleprompter, there is still ample opportunity for a speaker to misread or mispronounce a word or phrase. Nor do these scenarios typically permit additional takes for the speaker to correct a misspoken word.

As described fully herein, having determined that a portion of content comprises an incorrect word, a voice profile associated with the incorrect word's speaker featured in the content may be determined (e.g., created, accessed from storage, and/or updated) and used to generate a (correct) word to correct the incorrect word in the portion of the content. For example, spoken audio content indicating the correct word may be generated based on the voice profile. Because spoken audio content indicating the correct word is generated using the speaker's voice profile, it may resemble or mimic the speaker's own speech. In this manner, a viewer may not realize the correction once the spoken audio content indicating the correct word is mixed with the background audio in the portion of the content or otherwise inserted into the portion of the content. The incorrect word (e.g., spoken audio content indicating the incorrect word) may have been isolated or separated out from the background audio in the portion of the content, thus facilitating mixing the generated spoken audio content indicating the correct word with the background audio and/or inserting the generated spoken audio content indicating the correct word into the portion of the content to replace the original spoken audio content indicating the incorrect word.

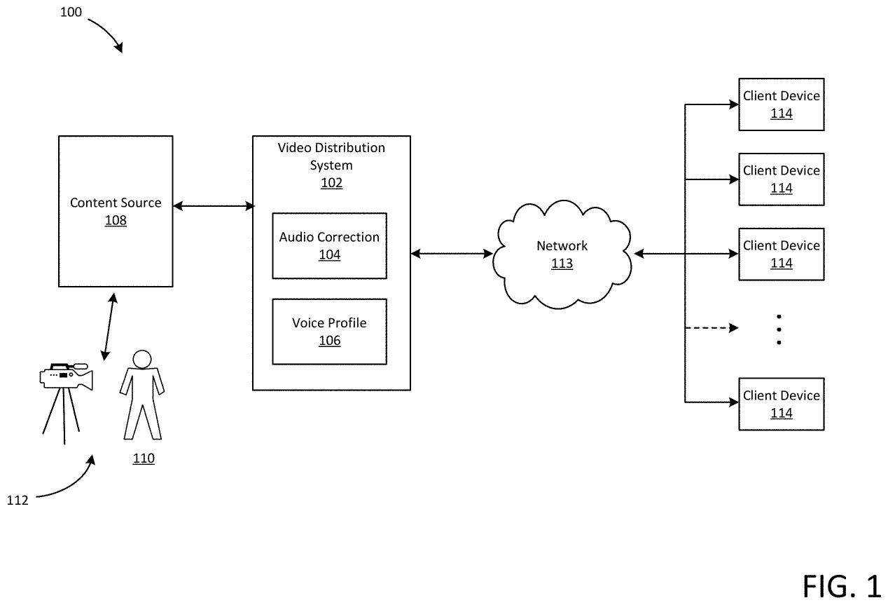

FIG. 1 illustrates a block diagram of a system 100 in which the present systems, methods, and devices may be implemented. The system 100 comprises a video distribution system 102 generally configured to distribute, via a network 113, content (e.g., video content) from a content source 108 to one or more client devices 114 for viewer consumption. The video distribution system 102 may comprise an audio correction module 104 and a voice profile module 106. The audio correction module 104 may generally identify incorrect words spoken in video content and replace those words with corresponding correct words. A replacement correct word may be generated based on a voice profile associated with the speaker of the incorrect word. Such voice profiles may be managed (e.g., stored, generated, updated, etc.) by the voice profile module 106.

The content source 108 may store and/or provide content for distribution to the client devices 114. The content source 108 may comprise stored video content, such as that anticipated to be delivered as digital streaming video, on-demand video, or cloud DVR recorded video. The content source 108 may comprise video content intended for immediate or near-immediate broadcast, such as a live television video feed. The content source 108 may comprise a linear content source. The content source 108 may be integrated with the video distribution system 102, separate from the video distribution system 102, or some combination thereof. Content may comprise audio-only content, such as a radio broadcast, or content with both audio and video components. Although the techniques described herein are discussed primarily in terms of audio/video content, they may be readily applied to audio-only content in the same or similar manner.

The content source 108 may provide, for example, on-camera content 112 in which a person (i.e., a speaker 110) speaks in front of a camera and/or microphone. Such on-camera content 112 may comprise, for example, a news program, a sports event broadcast (e.g., featuring one or more sports commentators or announcers), a game show, a talk show, or an awards program. The “on-camera” content 112 may comprise a radio broadcast, such as a radio broadcast of a sports event. The audio correction techniques described herein may prove particularly useful for this type of content since it often features un-scripted speech in which the speaker 110 may sometimes unintentionally say an incorrect word (although the application is not so limited). Furthermore, it is typically not possible to perform additional takes in which the speaker 110 may otherwise have been able to correct their initial use of an incorrect word. The on-camera content 112 may be live or recorded.

As noted, the video distribution system 102 may generally effectuate video content delivery to the client devices 114. The video distribution system 102 may deliver content as scheduled linear programming and/or deliver content as on-demand services (e.g., via a digital video stream). The video distribution system 102 may receive content from the content source 108, process that content (e.g., segment the content), and package the processed content as a digital video stream, such as an MPEG transport stream. The digital video stream may be generated according to one or more adaptive bitrate streaming technologies, such as Dynamic Adaptive Streaming over HTTP (MPEG-DASH), HTTP Live Streaming (HLS), Adobe HTTP Dynamic Streaming, or Microsoft Smooth Streaming. The video distribution system 102 may implement a cloud-based DVR system configured to deliver “recorded” video content upon request from a client device 114. The video distribution system 102 may be associated with a cable or satellite television operator.

The audio correction module 104 may generally determine that content comprises one or more incorrect words (e.g., spoken by a speaker) and automatically initiate steps to replace the incorrect(s) word in the content with corresponding correct word(s). For example, the audio correction module 104 may determine, such as via automatic content recognition (ACR), that a portion of content comprises an incorrect word (or multiple). A voice profile may be determined that is associated with the speaker of the incorrect word. For example, the voice profile module 106 may determine the voice profile based on the spoken audio content in the content portion that indicates the incorrect word (as opposed to background audio content in the content portion). The voice profile may be determined based on audio, vocal, and/or linguistic characteristics of the spoken audio content, such as audio spectral patterns, vocal frequency, vocal pitch, speaking speed, intonation, loudness, amplitude, speech patterns, speech cadence, the number and/or duration of utterances, the number and/or duration of breaks between utterances, etc. As such, the voice profile may characterize the speaker's speech according to these same (at least in part) audio, vocal, and/or linguistic characteristics. The voice profile may be used to generate spoken audio content with speech that resembles the speaker's other speech in the content. That is, spoken audio content generated based on a speaker's voice profile may include speech that sounds as it were actually spoken by the speaker.

The voice profile module 106 may store a plurality of voice profiles associated with various speakers (some of whom may or may not speak in the particular content). In this case, determining the voice profiled associated with the speaker may comprise selecting the voice profile, out of the plurality of voice profiles, that is associated with the speaker. The voice profile module 106 may additionally or alternatively generate a voice profile associated with the speaker based on spoken audio content associated with (e.g., spoken by) the speaker. The spoken audio content used to determine the speaker's voice profile may be from the instant content and/or other content in which the speaker speaks. The spoken audio content used to determine the speaker's voice profile may be from sample recordings of the speaker made for the purpose of determining the speaker's voice profile. Additionally or alternatively, determining the voice profile associated with the user may comprise selecting a generic voice profile, such as a selecting a generic voice profile, of a plurality of generic voice profiles, that most closely represents the speaker's speech. The voice profile module 106 may additionally or alternatively update the speaker's voice profile on an on-going (e.g., real-time) basis. For example, as the content is processed to identify and correct incorrect words, for each portion of the content determined to include spoken audio content associated with the speaker, that spoken audio content may be used to update the speaker's voice profile. In this manner, a feedback loop may be formed in which the speaker's voice profile is successively refined over the various portion of the content during which the speaker speaks. The feedback loop may comprise a machine learning algorithm in which the various instances of spoken audio content associated with the speaker are used as training data.

The audio correction module 104 may determine a correct word associated with the identified incorrect word in the portion of the content. For example, if the incorrect word is incorrect with respect to meaning, the audio correction module 104 may determine a word with the meaning intended by the incorrect word. If the incorrect word is incorrect with respect to pronunciation, the correct word may represent a correct pronunciation of that word. The correct word may be determined using rules- and/or dictionary-based techniques. For example, a machine-readable dictionary may comprise listings of incorrect words and correct words that may be cross-referenced to determine what correct word(s), if any, are associated with a given incorrect word. Additionally or alternatively, the correct word may be determined using a machine learning model configured to receive an incorrect word as an input and output an associated correct word. Determining the correct word may be further based on the voice profile associated with the speaker. For example, the analysis of the portion of the content to identify the incorrect word in the portion of the content may be informed by the various characteristic of the speaker's speech indicated in the voice profile.

The audio correction module 104 may replace the incorrect word in the portion of the content with the determined correct word. For example, the audio correction module 104 may determine the background audio content of the portion of the content. The background audio content may comprise the remainder of the audio content of the portion of the content besides the spoken audio content of the portion of the content. The background audio content may be determined by isolating or separating out each of the background audio content and the spoken audio content from the portion of the content, such as by applying blind source/signal separation (BSS) and/or linear predictive coding (LPC) to the portion of the content. The background audio content may comprise white noise in areas of the portion of the content that were associated with (e.g., comprised) the incorrect word. The audio correction module 104 may generate second spoken audio content indicating the correct word. The second spoken audio content may be generated using the voice profile associated with the speaker. As such, the correct word may be represented in the second spoken audio content in a similar manner as if the correct word was actually spoken by the speaker. The duration of the second spoken audio content may be expanded or contracted to match the original duration of the spoken audio content, along with any corresponding pitch adjustments to the second spoken audio content. The audio correction module 104 may further generate a second portion of content comprising the background audio content and the second spoken audio indicating the correct word. The second portion of content may be generated by mixing (e.g., overlapping and/or adding) the background audio content and the second spoken audio content. The second portion of content may include the correct word instead of the incorrect word, but may otherwise closely resemble the initial portion of the content, including with respect to the speaker's speech characteristics. The audio correction module 104 may replace, in the content, the initial portion of the content with the generated second portion of content (indicating the correct word).

Additionally or alternatively, for example, the audio correction module 104 may replace the incorrect word in the portion of the content with the determined correct word by removing the spoken audio content indicating the incorrect word from the portion of the content. Based on the voice profile associated with the speaker, the audio correction module 104 may generate second spoken audio content indicating the correct word. The audio correction module 104 may mix (e.g., overlap and/or add) the second spoken audio content with the background audio content in the portion of the content. In this case, the background audio content may have not been isolated or separated out from the portion of the content. Mixing the second spoken audio content with the background audio content may restore the portion of the content, except that the incorrect word is replaced with the correct word.

Additionally or alternatively, for example, the audio correction module 104 may determine the incorrect spoken word in the portion of content. The voice profile may be determined based on the incorrect spoken word (and/or the portion of the content generally). Based on the voice profile, the correct spoken word may be generated to replace the incorrect word in the portion of the content. The audio correction module 104 may remove the incorrect spoken word from the portion of the content and mix the correct spoken word with background audio in the portion of the content.

The audio correction module 104 may perform audio correction during content's post-processing stage. For example, audio correction may be performed on stored content, which may have already been packaging for distribution. Such content may have already been segmented, with a media presentation description (MPD) file or the like (e.g., a manifest file) indicating the segments, timing information, and other related information. During post-processing audio correction, the content (e.g., the entirety of the content) may be initially analyzed to identify any portions of the content that comprise one or more incorrect words. Those identified portions of the content with incorrect word(s) may be indicated in the MPD or the like, such as by the segment in which an identified portion is found and/or a start and end time of an identified portion. As described above (and elsewhere), the audio correction module 104 may, for each portion of the content with in incorrect word, determine a correct word, generate spoken audio content indicating the correct word based on a voice profile, and replace the spoken audio content indicating the incorrect word in the portion with the generated spoken audio content indicating the correct word. The identified portions of the content may comprise speech from the same speaker, in which case the same voice profile associated with the speaker may be used to generate the spoken audio content for each identified portion. The speaker may have already been determined in the initial analysis to identify the portions of the content indicating an incorrect word. For example, the speaker may be identified in the MPD file or the like associated with the content. The corrected content may be distributed to various client device(s) 114.

The audio correction module 104 may additionally or alternatively perform audio correction on live or real time content, including near-live and near-real time content, respectively. Here, the audio correction module 104 may analyze the content for any portions with incorrect words as the content becomes available and proceed to replace the spoken audio content of an identified portion with generated spoken audio content indicating the correct word. A slight delay may be introduced to compensate for any processing time lag. The corrected portions of the content, as well as any portions not requiring correction, may be distributed to various client devices 114 in live or real time, subject to the aforementioned delay.

A client device 114 may comprise any one of numerous types of devices configured to effectuate video playback and/or viewing. A client device 114 may comprise a display device, a computing device, or a mobile device. A client device 114 may be configured to receive video content and output the video content to a separate display device for consumer viewing. For example, a client device 114 may comprise a set-top box, such as a cable set-top box, a digital media player, or a gaming device. A client device 114 may comprise a digital video recorder (DVR) that receives and stores video content for later viewing. A client device 114 is not strictly limited to a video playback device, but may include a computing device more generally. A client device 114 may refer to a software “client” in addition to or instead of a hardware device.

The network 113 may comprise a private portion. The network 113 may comprise a public portion, such as the Internet. The network 113 may comprise a content distribution and/or access network. The network 113 may comprise a cable television network or a content delivery network. The network 113 may facilitate communication via one or more communication protocols. The network 113 may comprise fiber, cable, or a combination thereof. The network 113 may comprise wired links, wireless links, a combination thereof, and/or the like. The network 113 may comprise routers, switches, nodes, gateways, servers, modems, and/or the like.

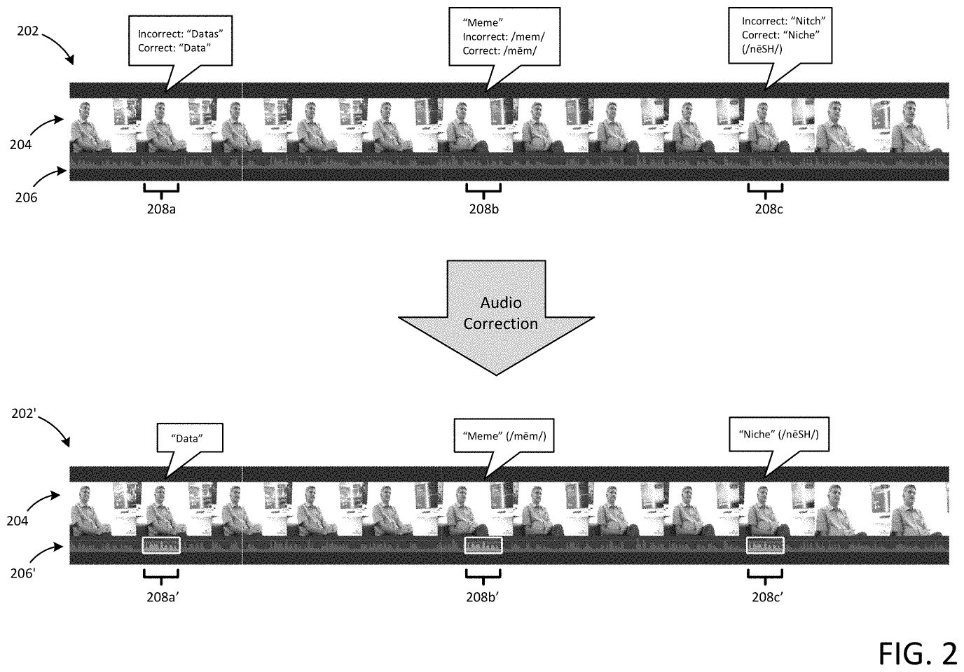

FIG. 2 shows example content 202 comprising video content 204 and audio content 206 (represented as an audio spectrogram). Although not distinguishable in the figure, the audio content 206 comprises, to varying degrees, spoken audio content and background audio content. The spoken audio content may comprise speech from the person visible in the video content 204. The content 202 may undergo audio correction to determine corrected content 202′. The corrected content 202′ may comprise corrected audio content 206′. The video content 204 in the corrected content 202′ may remain generally unchanged from the initial content 202. The audio correction shown in FIG. 2 may represent post-processing audio correction. For example, the entirety of the content 202 may be analyzed for incorrect words before replacing those incorrect words with correct words.

The audio correction may determine that first, second, and third portions 208a-c of the content 202 (and by extension the audio content 206) comprise spoken audio content indicating an incorrect word. In the first portion 208a, the speaker said “datas,” whereas the intended word was “data.” In the second portion 208b, the speaker wished to say “meme” but mispronounces it as /mem/ instead of /mēm/ (rhyming with “seem” or “deem”). In the third portion 208c, the speaker says “nitch” instead of the correct “niche” (pronounced /nēSH/; rhyming with “quiche”). For each of the first, second, and third portions 208a-c, the audio correction may determine a correct word, which, as just explained, are “data,” /mēm/, and “Niche,” respectively.

The audio correction may determine a voice profile, such as a voice profile associated with the speaker featured in the video. The voice profile may be determined based on the spoken audio content in the audio content 206, such as via speech recognition and/or speaker recognition techniques. The voice profile may be determined with respect to each of the first, second, and third portions 208a-c or the voice profile may be determined a single time and applied to all three portions 208a-c (e.g., when sharing a common speaker). The voice profile may be continuously (e.g., in real time) monitored and updated as the various portions (e.g., the first, second, and third portions 208a-c) of the content 202 are analyzed. For example, the initial voice profile associated with the speaker may be determined with respect to the first portion 208a. As the second portion 208b is analyzed for audio correction, the spoken audio content of the second portion 208b may be used to update the voice profile to more accurately reflect the various characteristics of the speaker's speech. The spoken audio content (if any) in the portions of the content 202 between the first portion 208a and the second portion 208b may be additionally or alternatively used to update the voice profile. The spoken audio content of the third portion 208c may be similarly used to update the voice profile, as well as (additionally or alternatively) any intervening portions between the second portion 208b and the third portion 208c.

Based on the voice profile associated with the speaker, the audio correction may generate spoken audio content indicating a respective correct word for each of the three portions 208a-c. For example, with respect to the portion 208a and the correct portion 208a′, the background audio content and spoken audio content in the audio content 206 may be determined, such as via BSS and/or LPC. Based on the spoken audio content (e.g., the incorrect word(s)) in the portion 208a) and the voice profile, the corrected spoken audio content (indicating the correct word(s)) in the corrected portion 208a′ (e.g., in the corrected audio content 206′ of the corrected portion 208a′) may be generated to replace the original spoken audio content (e.g. the incorrect word(s)). The background audio content of the original portion 208a and the newly-generated corrected spoken audio content may be mixed (e.g., merged, overlaid, and/or added) to generate the corrected portion 208a′. The corrected portion 208a′ may be stitched into the original content 202 to replace the portion 208a. Similar steps may be performed with respect to the second portion 208b and the third portion 208c.

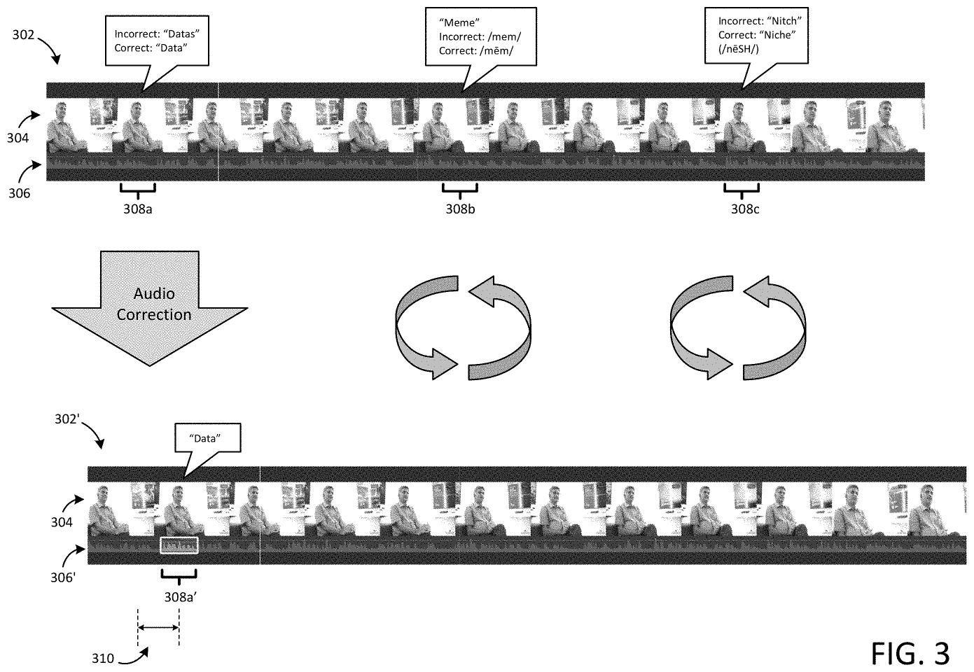

FIG. 3, similar to FIG. 2 in some respects, shows example content 302 comprising video content 304 and audio content 306 (represented as an audio spectrogram). Although not distinguishable in the figure, the audio content 306 comprises, to varying degrees, spoken audio content and background audio content. The content 302 may undergo audio correction to determine corrected content 302′, including corrected audio content 306′. The video content 304 in the corrected content 302′ may remain generally unchanged from the initial content 302.

The audio correction shown in FIG. 3 may represent live or real time audio correction. The content 302 may comprise live or real-time content, such as a linear feed from a content source. For example, portions of the content 302 may be analyzed as they become available to determine whether an instant portion indicates an incorrect word, in which case audio correction may be performed with respect to that portion. In the example shown in FIG. 3, the first portion 308a may be ingested and available for audio correction analysis before the second portion 308b and the third portion 308c.

It may be initially determined that the first portion 308a (e.g., the spoken audio content of the audio content 306 of the first portion 308a) indicates the incorrect word “datas,” as opposed to the correct word “data.” A voice profile associated with the first portion 308a may be determined, such as a voice profile associated with the speaker shown in the video content 304. Determining the voice profile may comprise monitoring and updating the voice profile in real time based on the first portion 308a. The background audio content and the spoken audio content of the first portion 308a may be determined. Distinguishing the background audio content and the spoken audio content may occur before or after determining the voice profile. In the former case, determining the voice profile may be based on the spoken audio content of the first portion 308a in particular, while ignoring the background audio content. Based on the voice profile, corrected spoken audio content (indicating the correct word “data”) may be determined. The corrected spoken audio content and the background audio content may be mixed (e.g., merged, overlaid, added) to determine the corrected first portion 308a′ (e.g., the corrected audio content 306a of the corrected first portion 308a′). The corrected first portion 308a′ may be distributed to client devices. To compensate for the processing time in the audio correction, a delay 310 may be introduced.

As the content 302 is further ingested and available for audio correction analysis, successive portions of the content 302 may be analyzed to determine whether the portion indicates an incorrect word, in which case audio correction may be implemented with respect to that portion to correct the word. For example, when the second portion 308b is available for audio correction analysis, it may be determined that the second portion 308b indicates the incorrect word “meme” mispronounced as /mem/ instead of /mēm/. In a similar manner as with the first portion 308a, audio correction may be thus performed to determine a second corrected portion (not shown in FIG. 3) in the corrected content 302′ indicating the correct pronunciation /mēm/. Presuming that the voice profile associated with the speaker was previously determined (e.g., updated) in the audio correction analysis for the first portion 308a, the voice profile may be monitored and updated at this time based on the spoken audio content of the second portion 308b. The updated voice profile may be used to generate the aforementioned second corrected portion in the corrected content 302′. Similarly, as the third portion 308c of the content becomes available for audio correction analysis, it may be determined that the third portion 308c indicates the incorrect word “nitch” instead of the correct word “niche.” In a manner similar to that of the audio correction for the first portion 308a and the second portion 308b, a third corrected portion (not shown in FIG. 3) in the corrected content 302′ indicating the correct word “niche” may be determined. The voice profile associated with the speaker may be monitored and updated at this time based on the spoken audio content of the third portion 308c. The updated voice profile may be used to generate the third corrected portion in the corrected content 302′.

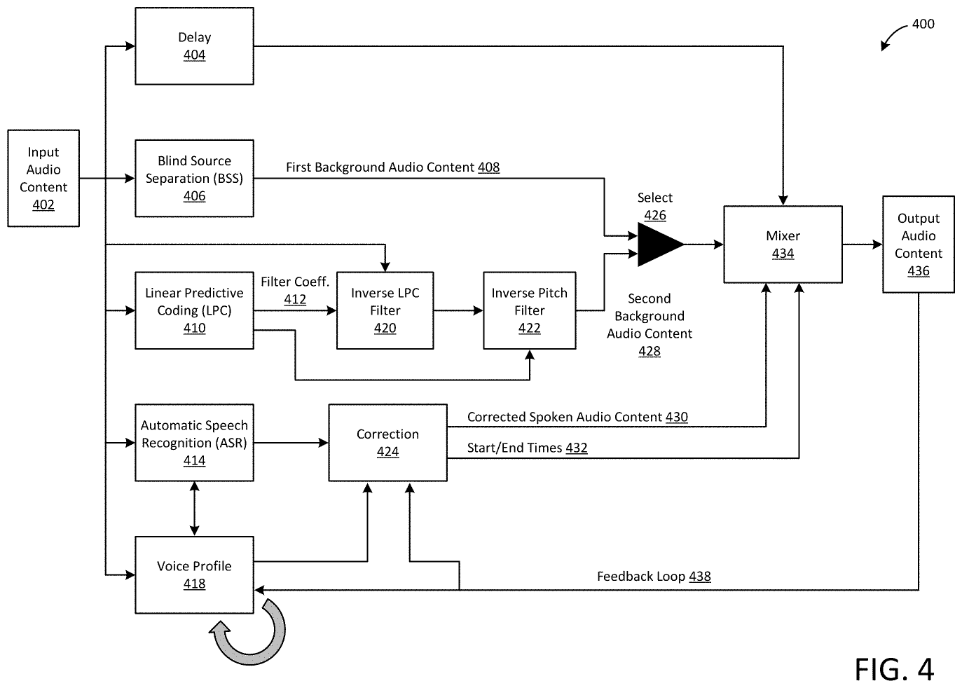

FIG. 4 shows an example block diagram 400 relating to audio correction applied to input audio content 402 to determine output audio content 436. The input audio content may comprise one or more incorrect words that are corrected by one or more corresponding correct words in the output audio content 436. The techniques shown in FIG. 4 may be implemented by the video distribution system 102 of FIG. 1, including the audio correction module 104 and/or the voice profile module 106. The input audio content 402 may comprise speech by one or more speakers (and/or speech from other sources, such as digital or computer-generated speech) and/or background audio.

The input audio content 402 may be received from the content source 108 of FIG. 1. The input audio content 402 may be received in conjunction with video content. For example, the input audio content 402 may be the audio component of audio/video content, such as a digital video stream or linear digital television programming. The audio content 206 of FIG. 2 and the audio content 306 of FIG. 3 provide additional examples of the input audio content 402. The input audio content 402 may comprise a plurality of portions of audio content. A portion of audio content may comprise spoken audio content (e.g., speech) and background audio content. The spoken audio content may comprise (e.g., indicate) one or more words. The spoken audio content and/or the one or more words may be associated with a speaker. The portions of the input audio content 402 may be predetermined and uniform across the input audio content 302 or the portions of the input audio content 402 may be dynamically defined and/or have non-uniform durations. As an example of the latter, a portion may be defined based on the portion comprising an incorrect word. That is, the start and stop times of the portion may generally coincide with the start and stop times of the incorrect word (e.g., the start and stop times of the spoken audio content indicating the incorrect word). The portion may include a short buffer (e.g., 1 to 4 milliseconds) on either side of the incorrect word.

Based on the input audio content 402, such as the spoken audio content (speech) thereof, a voice profile module 418 (e.g., the voice profile module 106 of FIG. 1) may determine a voice profile associated with a speaker in the input audio content 402 or portion thereof (e.g. associated with the spoken audio content from the speaker). The voice profile may be determined based on audio, vocal, and/or linguistic characteristics of the spoken audio content, such as audio spectral patterns, vocal frequency, vocal pitch, speaking speed, intonation, loudness, amplitude, speech patterns, speech cadence, the number and/or duration of utterances, the number and/or duration of breaks between utterances, etc. The voice profile may be preferably representative of the speaker's voice and mode of speech such that the voice profile may be used to generate spoken audio content that imitates the speaker's actual speech (or a best approximation thereof).

A voice profile associated with the speaker may be initially determined (e.g. from scratch) based on the input audio content 402. For example, the voice profile associated with the speaker may be initially determined at the time of, and/or based on, an audio correction analysis of a first portion of the input audio content 402 analyzed.

A voice profile may have been previously generated. The previously-generated voice profile may be already associated with the speaker. For example, the voice profile may have already been generated during an audio correction analysis of another portion of the input audio content 402 or during an audio correction analysis of a different instance of audio content. The speaker and/or his or her voice profile may be indicated in association with the input audio content 402. For example, the speaker and/or his or her voice profile may be indicated in a manifest file (e.g., an MPD file or the like) and/or metadata associated with the input audio content 402. The manifest file and/or metadata may indicate the portions of the input audio content 402 that as associated with the speaker. The voice profile module 418 may retrieve the speaker's voice profile from storage based on the identification of the speaker in the manifest file or metadata (or via other means). A previously-generated voice profile may comprise a generic voice profile, such as a generic profile selected from a plurality of generic voice profiles. The selected generic profile may most closely match the speech characteristics of the instant speaker out of the plurality of generic voice profiles.

A voice profile associated with a speaker may be determined via manual training techniques in which the speaker reads aloud a series of prewritten lines of text over multiple iterations. The sound recording of the speaker reading the prewritten lines may be used as training data to determine the voice profile. Machine learning techniques may be used here to determine the voice profile based on the prewritten lines and the sound recordings of the speaker reading the same.

As indicated by the circular arrow in FIG. 4, the spoken audio content in the input audio content 402 may be continuously monitored in real time (e.g., on a per-portion basis, in particular those portions comprising speech by the speaker), with the voice profile, whether it is a generic voice profile or already specific to the speaker, being updated accordingly (e.g., based on each analyzed portion of the input audio content 402 comprising speech by the speaker). Additionally or alternatively, the output audio content 436 may be analyzed to provide a feedback loop 438 to the voice profile module 418. The feedback loop 438 may generally indicate how well a spoken correct word inserted into the output audio content 436 resembles the speaker's actual speech (e.g., the speaker's other speech in the output audio content 436) or other metrics relating to the inserted correct word (such as whether the replaced incorrect word and/or other contextual words were properly recognized (generally) in the input audio content 402 and translated to text, whether the replaced incorrect word was properly identified as in fact being incorrect, whether the inserted correct word is in fact a correction to the incorrect word, or the extend to which the correct word is the most appropriate correction within the context of the speech). The feedback loop 438 may be based on a manual analysis of the output audio content 436 and/or an automated analysis of the output audio content 436.

The voice profile module 418 and/or the feedback loop 438 may comprise a machine learning model configured to determine a voice profile. The feedback loop 438 may provide training data (e.g., a training data output) for refining the machine learning model. Depending on the implementation, the machine learning model may be updated based on an audio correction analysis of each portion of the input audio content 403, such as the audio, vocal, and/or linguistic characteristic of the spoken audio content of each portion.

In any case, the term “determining,” as applied to determining the voice profile, may encompass any of generating or creating a new voice profile, accessing a voice profile from storage, selecting a voice profile from a plurality of voice profiles, updating a voice profile already associated with the speaker, or updating a generic voice profile not already associated with the speaker.

The input audio content 402 may be subject to automatic speech recognition (ASR) 414 to determine the actual words indicated (e.g., spoken) in the input audio content 402 (e.g., in spoken audio content in the input audio content 402). The ASR 414 may analyze one portion of the input audio content 402 at a time and recognize and translate any speech in that portion. The ASR 414 may employ acoustic modeling and/or language modeling. The ASR 414 may perform speaker recognition to determine the identity of a speaker. The ASR 414 may output the recognized words as text.

The ASR 414 may be informed by the voice profile module 418 and vice versa. For example, having access to a speaker's voice profile and the audio, vocal, and linguistic characteristics indicated in the speaker's voice profile may enable the ASR 414 to more accurately recognize and translate the speaker's speech. For example, the speaker's voice profile may indicate that the speaker says a word using a first (correct) pronunciation rather than a second (also correct) pronunciation. By matching at least some of the audio, vocal, and linguistic characteristics (associated with the first pronunciation) indicated in the speaker's voice profile with similar characteristics in the input audio content 402, the ASR 414 may determine that the speaker is speaking in the input audio content 402 and/or particular portion thereof. Additionally or alternatively, the voice profile module 418 may provide a plurality of possible speakers and respective voice profiles. For example, the input audio content 402 may feature multiple speakers, such as an interview host and one or more interviewees. The ASR 414 may determine which of the speakers is speaking in a given portion of the input audio content 402 by comparing the audio, vocal, and linguist characteristics of the portion with those indicated in the plurality of voice profiles. The speaker with the most closely matching audio, vocal, and linguistic characteristics may be determined as the speaker in the portion.

Conversely, the speech recognized in a portion of the input audio content 402 by the ASR 414 may be used by the voice profile module 418 to aid in determining a voice profile associated with a speaker in the portion of the input audio content 402. For example, the speech recognized in the portion may reveal audio, vocal, and linguistic characteristics relating to word choices/preferences, phrase construction, word patterns, prevalence of filler words (“um” or “uh”), etc. These characteristics may be used to select a voice profile from a plurality of stored voice profiles, determine a new voice profile, or update an existing voice profile.

Based on the speech recognized in the input audio content 402 (e.g., the words indicated in spoken audio content in the input audio content 402) by the ASR 414 and/or the voice profile associated with the spoken audio content in the input audio content 402 (e.g., the speaker of the spoken audio content), a correction module 424 may determine that a portion of the input audio content 402 comprises spoken audio content that indicates an incorrect word (or multiple incorrect words) that should be corrected. For example, the correction module 424 may determine that one of the words recognized by the ASR 414 is an incorrect word. As indicated above, the start and stop times of the portion of the input audio content 402 may generally coincide with the start and stop times in the input audio content 402 of when the incorrect word was spoken, plus an optional short buffer on either side of the incorrect word.

Determining that the portion of the spoken audio content indicates an incorrect word may comprise determining a meaning of the incorrect word, as well as meanings of any associated words (e.g., the other words of the sentence, utterance, expression, etc. comprising the incorrect word). The meaning of these associated words may provide contextual information for identifying the incorrect word, such as to resolve an ambiguity between several possible meanings. Determining that the portion of the spoken audio content indicates the incorrect word may be additionally or alternatively based on the spoken audio content itself, as well as the audio, vocal, and/or linguistic characteristics of the spoken audio content. This may be useful in determining that a word is incorrect with respect to pronunciation since this may be otherwise challenging to determine based on text alone (although the disclosure is not so limited). Audio, vocal, and/or linguistic characteristics, such as intonation, stressed syllables, stressed words, etc. may be also useful in determining a word's meaning and/or whether it is pronounced correctly (and thus whether it is deemed incorrect or not).

Having determined that a word is incorrect, as well as (optionally) the reason(s) that the word is incorrect or in what respect the word is incorrect, the correction module 424 may determine a correct word to take the place of the incorrect word in the output audio content 436. As noted above, a word may be characterized as incorrect or correct with respect to meaning (e.g., semantic meaning, including nonsensical meaning, or word choice, including profanity), pronunciation, or grammar (e.g., verb tense, plural/singular form, grammatical case, verb conjugation, or sentence structure). An incorrect word may be more generally characterized as a word that is to be replaced by another word (or words) in the output audio content 436, even if it is not per se incorrect (e.g., with respect to meaning, pronunciation, or grammar). For example, a television program may enact a policy in which any spoken instances of “Indian” are to be replaced with “Native American.” As another example, a television news program may wish to normalize the accents spoken by the various news casters and reporters, in which case a word pronounced with a non-standard accent may be considered an incorrect word (with the same word pronounced with the normalized accent being considered the associated correct word). As another example, the audio correction techniques described herein may be used to censor any profanity found in input audio content. Here, any designated curse words, swear words, slurs, expletives, or the like (incorrect words) may be replaced with a less objectionable word (correct words) having the same or similar meaning. A listing of profane words to be censored and their respective inoffensive counterparts may be maintained. Additionally or alternatively, a profane word may be replaced with a bleep or other tone.

The correction module 424 may determine a correct word to replace the incorrect word via machine learning, for example. The correction module 424 may determine a machine learning model configured to receive the incorrect word as an input and output a corresponding correct word. The output may comprise a most-probable correct word. Additionally or alternatively, the output may comprise multiple most-probable correct words (e.g., the first most-probable correct word, the second most-probable correct word, etc.). The machine learning model may be determined via the feedback loop 438. For example, based on manual and/or automated review of output audio content 436, including any word corrections therein, the feedback loop 438 may indicate whether, or to what degree, a word selected to replace a corresponding incorrect word is in fact “correct.” The feedback loop 438 may indicate an in-fact correct word that should have been selected, one or more words that would have been preferable over the selected word, and/or one or more words that would have been equally acceptable to the selected word. The feedback loop 438 may be used as training data to determine the machine learning model.

Additionally or alternatively, the correction module 424 may determine the correct word via rules- and/or dictionary-based techniques. For example, a series of rules may be applied to the incorrect word and any associated audio, vocal, or linguistic characteristics, with the result(s) being input to a machine-readable dictionary. A machine-readable dictionary may comprise listings of incorrect words and correct words that may be cross-referenced to determine what correct word(s), if any, are associated with a given incorrect word. The correction module 424 may determine a first potential correct word (or multiple words) via the machine learning and a second potential correct word (or multiple) via the rules/dictionary-based techniques. The correction module 424 may determine whether to use the first word determined via the machine learning or the second word determined via the rules/dictionary-based techniques as the correct word.

The correction module 424 may determine (e.g., generate) corrected spoken audio content 430 that indicates (e.g., comprises), at least in part, the determined correct word. The corrected spoken audio content 430 may be determined based on the voice profile associated with the spoken audio content indicating the incorrect word (e.g., associated with the speaker). As noted above, the voice profile may indicate audio, vocal, and/or linguistic characteristics that are based on the original spoken audio content from the speaker in the input audio content 402 (which may include the portion of the spoken audio content/input audio content 402 indicating the incorrect word and/or other portions of the spoken audio content/input audio content 402) and/or entirely other spoken content audio. Via the audio, vocal, and linguistic characteristics thereof, the voice profile may be generally representative of the speaker's manner of speech and voice. As such, the corrected spoken audio content 430 indicating the correct word aims to sound as if it was actually spoken by the speaker and preferably go unnoticed by viewers that the correction took place.

The corrected spoken audio content 430 may sometimes have a different length or duration than that of the portion of the spoken audio content, indicating the incorrect word, of the input audio content 402 that the corrected spoken audio content 430 is meant to replace. In this case, the corrected spoken audio content 430 may be expanded or contracted so that its length or duration matches that of the portion of the spoken audio content indicating the incorrect word. Adjustments to the pitch or other characteristics of the expanded or contracted corrected spoken audio content 430 may be made to disguise the fact that it was expanded or contracted.

The start and end times 432, with respect to the input audio content 402, of the corrected spoken audio content 430 may be determined. The start and end times 432 may indicate where in the input audio content 402 the corrected spoken audio content 430 should be inserted.

In addition to determining the corrected spoken audio content 430, the background audio content of the input audio content 402 may be determined. As described in greater detail herein, the background audio content may be mixed with the corrected spoken audio content 430, via the mixer 434, to determine the output audio content 436. The background audio content and the corrected spoken audio content 430 may be determined in any order or simultaneously.

The determined background audio content may comprise the background audio content in the portion of the input audio content 402 that also includes the spoken audio content indicating the incorrect word determined via the correction module 424. Background audio content may generally refer to the audio content of the input audio content 402 other than the primary spoken audio content analyzed by the ASR 414, voice profile module 418, and correction module 424. In other words, background audio content may refer to all audio content besides the analyzed primary spoken audio content (if any). Examples of background noise may include music, wind or rain (e.g., during an on-location news report), applause (e.g., during a talk show or game show), or paper rustling. It is noted that background audio content may sometimes include other secondary spoken audio content, such as if a news reporter (the source of the analyzed primary spoken audio content-a primary speaker) is reporting amongst a crowd of people (causing background spoken audio content). Unless clearly indicated otherwise, the term spoken audio content shall refer to that of the primary speaker rather than to that of any secondary speakers. The background audio content may be additionally or alternatively characterized as the input audio content 402 with the corresponding spoken audio content removed (e.g., replaced with white noise).

The background audio content may be determined via one or more of blind source/signal separation (BSS) 406 or linear predictive coding (LPC) 410. The BSS 406 may determine first background audio content 408 and the LPC 410 may determine second background audio content 428. If both the first background audio content 408 and the second background audio content 428 are both determined, a select function 426 may select one of the two for mixing with the corrected spoken audio content 430 to determine the output audio content 436. Alternatively, only one of the BSS 406 and LPC 410 may be utilized, in which case the select function 426 may be removed or bypassed. The BSS 406 may be more apt where the input audio content 402 comprises mostly (e.g., greater than fifty percent) background audio content. The BSS 406 may be used when the input audio content 402 is captured via multiple microphones and/or comprises a left/right stereo signal, although this is not required. The BSS 406 may additionally or alternatively determine the first background audio content 408 when the input audio content 40 is captured via a single microphone. The LPC 410 may be more apt where the input audio content 402 comprises mostly (e.g., greater than fifty percent) spoken audio content. The first background audio content 408 or the second background audio content 428 may be selected according to which of these conditions presently exist and/or are expected to exist.

As noted, the first background audio content 408 may be determined via the BSS 406. The BSS 406 may separate the input audio content 402 into a plurality of signals. That is, the BSS 406 may determine a plurality of signals that together constitute the input audio content 402. The separate signals may sometimes be referred to as channels in this and similar technology. Each signal may correspond to an audio source in the input audio content 402. For example, the sources may comprise a speaker, a music source, and an audience's applause. The BSS 406 may determine an audio signal for each of the speaker, music source, and the audience's applause. The BSS 406 may determine which of these audio signals is associated with the spoken audio content (e.g., the speaker's speech) that is to be analyzed and potentially subjected to audio correction if one or more incorrect words are detected. Although not visually indicated in FIG. 4, the BSS 406, in particular determining the audio signal associated with the speaker (e.g., the spoken audio content), may be based on one or more voice profiles, such as the voice profile associated with the speaker. For example, there may be some similarities between the audio, vocal, and/or linguistic characteristics indicated in the speaker's voice profile and audio, vocal, and/or linguistic characteristic associated with the speaker's audio signal in the BSS 406. A second voice profile may be used in a similar manner to determine a secondary second speaker (whose audio is not intended to be corrected), etc. The BSS 406 may determine which of the separated audio signals is associated with the speaker and which are associated with some other source. The signals associated with the other (non-speaker) sources may constitute the first background audio content 408. The other (non-speaker) signals may remain separated in the first background audio content 408 or may be recombined. Determining the first background audio content 408 may comprise removing the signal (i.e., the spoken audio content) associated with the speaker from the input audio content 402.

The second background audio content 428 may be determined via the LPC 410. The LPC 410 may initially determine one or more characteristics (e.g., audio, vocal, and/or linguistic) associated with the spoken audio content of the input audio stream 402. Based on those characteristics of the spoken audio content and the input audio content 402, and via a filter coefficient 412 determined by the LPC 410, an inverse LPC filter 420 is determined. The inverse LPC filter 420 may determine residual audio content by nulling out audio signals in the input audio content having those determined characteristics associated with the spoken audio content. The residual audio content may comprise background audio content. An inverse pitch filter 422 may be determined (e.g., based on the characteristics associated with the spoken audio content determined by the LPC 410 and/or the inverse LPC filter 420). By removing the characteristics of the spoken audio content determined by the LPC 410, the inverse pitch filter 422 may provide a “whitening effect” to the residual audio content (background audio content). The whitening effect may cause the spoken audio content to become white noise while the background audio content remains. The background audio content with white noise may be output by the inverse pitch filter 422 as the second background audio content 428.

If both are determined, one of the first background audio content 408 or the second background audio content 428 may be selected via the select function 426. If only one of the first background audio content 408 and second background audio content 428 is determined, that background audio content is “selected” by default. The mixer 434 may mix (e.g., overlap and/or add) the selected background audio content with the corrected spoken audio content 430 to determine the output audio content 436 with the correct word associated with the incorrect word identified in the input audio content 402. The mixer 434 may mix the selected background audio content and the corrected spoken audio content 430 to generate a corrected portion of audio content that comprises both the selected background audio content and the corrected spoken audio content 436. The corrected spoken audio content 436 may mask any white noise (if applicable) and/or any residual spoken audio in the selected background audio content. The generated corrected portion of audio content may be stitched into the input audio content 402 to replace the corresponding portion of the input audio content 402 that indicated the incorrect word. The generated corrected portion of audio content may be stitched into the input audio content 402 according to the start and end times 432, which may account for a processing delay and/or include short overlap buffers at the beginning and end of the portion (or the mixer 434 may handle such a delay and/or buffers).

The mixer 434 may determine whether an instant portion of the input audio content 402 comprises spoken audio content indicating an incorrect word (or multiple). The correction module 424 may provide such a signal to the mixer 434, for example. As described above, if the mixer 434 determines that an instant portion of the input audio content 402 comprises spoken audio content indicating an incorrect word, the mixer 434 may mix the selected background audio content associated with the instant portion and the corrected spoken audio content 430 associated with the instant portion (e.g., indicating a correct word associated with the incorrect word) to generate a corrected portion of audio content associated with the instant (incorrect) portion. The mixer 434 may insert the generated corrected portion of audio content into the input audio content 402 at the start and end times 432 to replace the instant (incorrect) portion of audio content in the input audio content 402. The short buffers at the beginning and end of the corrected portion of audio content may be mixed and/or overlapped with the adjacent audio content in the input audio content 402 (via fade-in and fade-out effects) to provide a smooth transition into and out of the inserted corrected audio content.

If the mixer 434 determines that an instant portion of the input audio content 402 does not comprise spoken audio content indicating an incorrect word, the mixer 434 may access a delay 404 comprising the input audio content 402 and provide that as a corresponding portion of the output audio content 436. The input audio content 402 of the delay 404 is configured with a predetermined time delay to account for the time required of any audio correction processing that may occur.

The output audio content 436 may comprise a plurality of portions of audio content. The plurality of portions of audio content may comprise one or more portions of audio content each comprising un-modified spoken and background audio content from the input audio content 402 (e.g., via the delay 404). The plurality of portions of audio content may comprise one or more corrected portions of audio content each comprising spoken audio content indicating a correct word and background audio content from which spoken audio content indicating the corresponding incorrect word was removed. The output audio content 436, along with the associated video content, may be distributed to one or more client devices for consumption.

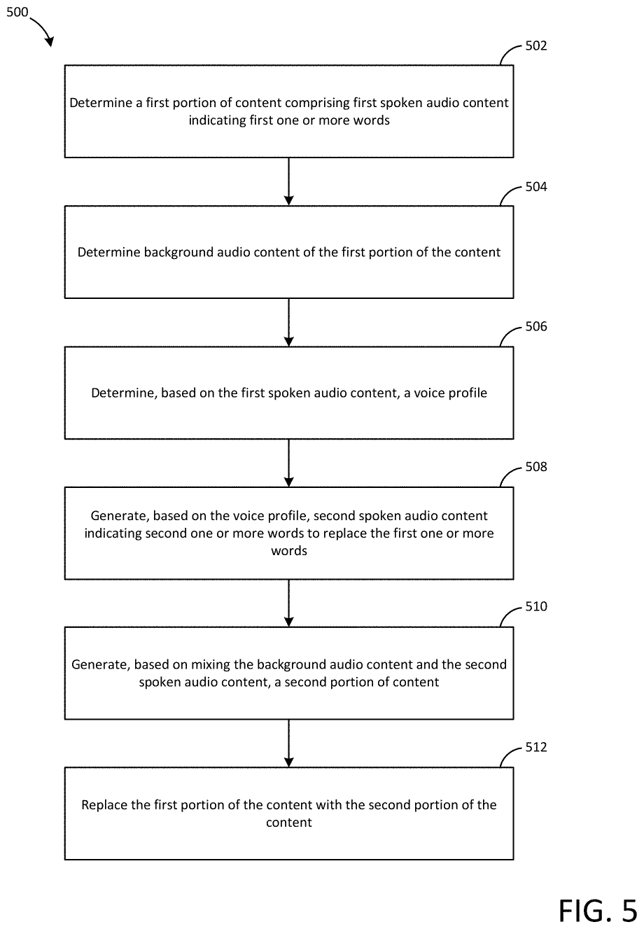

FIG. 5 shows a method 500. The method 500 may relate to audio correction, such as correcting one or more (incorrect) words in audio content. Audio content may intermittingly comprise spoken audio content generally reflecting speech from a speaker in the content. The speaker may sometimes inadvertently use a word with a different meaning than intended (including a nonsensical word or profanity), mispronounce a word, or use incorrect grammar when speaking a word (or there is otherwise a reason to deem a word “incorrect”). The method 500 may be used to monitor content (e.g., monitor in real-time) to identify any such incorrect words in the content and correct the incorrect words by replacing them with respective “correct” words that were generated using a voice profile associated with the speaker. The method 500 may be performed by the video distribution system 102 of FIG. 1, including the audio correction module 104 and the voice profile module 106.

At step 502, a first portion of content comprising first spoken audio content indicating first one or more words is determined. The content may generally comprise audio content (e.g., the input audio content 402 of FIG. 4) or the content may generally comprise audio-video content (“video”) (e.g., the content 202 and 302 of FIGS. 2 and 3, respectively) with video content (e.g., the video content 204 and 304 of FIGS. 2 and 3, respectively) and audio content (e.g., the audio content 206 and 306 of FIGS. 2 and 3, respectively). The first spoken audio content and/or the first one or more words may be associated with (e.g., spoken by) a speaker featured in the content. A speaker many often be a person speaking into a camera, such as a reporter, talk show host, newscaster, etc. However, it will be understood that spoken audio content, “speech,” and/or words indicated in spoken audio content need not be human-generated, but may be additionally or alternatively computer-generated (e.g., machine-generated). That is, a “speaker” may be a computer-generated voice. Audio content comprising computer-generated speech shall be considered as “spoken” audio content.

The first one or more words may be generally characterized as one or more words that are to be replaced with one or more other words. The first one or more words may comprise one or more incorrect words that are to be corrected by replacing the one or more incorrect words with associated correct words. A word may be deemed incorrect or correct with respect to one or more of meaning, pronunciation, or grammar. Accordingly, determining the first portion of the content (or the method 500 generally) may comprise determining that the first one or more words comprise at least one incorrect word that is to be replaced with at least one correct word. The at least one correct word may be in a portion of content that is to replace the first portion of content (e.g., the below-referenced second portion of content and/or second spoken audio content). The first one or more words may all be incorrect words or the first one or more words may comprise at least one incorrect word and at least one word that is not incorrect.

The first portion of the content comprising the first spoken audio content indicating the first one or more words may be determined via automatic speech recognition (ASR) (e.g., the ASR 414 of FIG. 4), such as applying ASR to the content to identify any portions of the content that comprise spoken audio content and determine the words spoken in the spoken audio content. ASR may be additionally or alternatively applied to just the spoken audio content (which may have already been separated out or suppressed via BSS and/or LPC) to determine the words spoken therein. The first portion of the content comprising the first spoken audio content indicating the first one or more words may be determined by the audio correction module 104 of FIG. 1 and/or the audio correction module 424 of FIG. 4.

At step 504, background audio content of the first portion of the content is determined. The background audio content may generally comprise the remainder of the first portion of content other than the first spoken audio content. The background audio content may comprise music, pen or paper rustling, wind or noises during an on-location news report, secondary background speech, and the like. The background audio content may be determined via one or more of blind source/signal separation (BSS) (e.g., the BSS 406 of FIG. 4) or linear predictive coding (LPC) (e.g., the LPC 410 of FIG. 4). The background audio content may be determined by separating out or removing the background audio content from the first portion of content (and/or the content generally). For example, the various separate sources/signals of the content determined via BSS may comprise a signal/source associated with the first spoken audio content (and/or the speaker). The remainder signals/sources of the content may be associated with background noises, music, etc. and collectively constitute the background audio content. Additionally or alternatively, LPC may determine the background audio content by determining one or more characteristics (e.g., audio, vocal, and/or linguistic) associated with spoken audio content (e.g., the first spoken audio content) and then nulling out audio signals in the content that are associated with (e.g., have or are characterized by) those one or more characteristics, resulting in residual audio content. The residual audio content may comprise the background audio content. A whitening or white noise effect may be applied to the background audio content and/or the first portion of the content such that the background audio content comprises a white noise in portions of the audio spectrum that were initially occupied by the first spoken audio content. Separating out or removing the first spoken audio content from the first portion of the content may comprise applying a whitening or white noise effect to the first spoken audio content.

At step 506, a voice profile is determined based on the first spoken audio content. The voice profile may be additionally or alternatively determined based on the first one or more words. The voice profile may be associated with a speaker of the first one or more words. The voice profile may be generally representative of the speaker's speech such that the voice profile may be used to generate spoken audio content. The voice profile may indicate various characteristics of the speaker's speech, such as audio, vocal, and/or linguistic characteristics. Example audio, vocal, and/or linguistic characteristics may include audio spectral patterns, vocal frequency, vocal pitch, speaking speed, intonation, loudness, amplitude, speech patterns, speech cadence, the number and/or duration of utterances, the number and/or duration of breaks between utterances, etc. Accordingly, the voice profile may be determined based on similar characteristics of the spoken audio content and/or the first one or more words spoken by the speaker.

Determining the voice profile may comprise determining a new voice profile for the speaker (e.g., creating the voice profile from scratch). Additionally or alternatively, determining the voice profile may comprise updating or revising a voice profile associated with the speaker that was previously created. Additionally or alternatively, determining the voice profile may comprise selecting a voice profile from a plurality of existing voice profiles. The selected voice profile may indicate audio, vocal, and/or linguistic characteristics that most resemble those of the speaker. The content may be marked (or otherwise configured) to identify the instant speaker (and/or other speakers) as speaking in the content. The content may be additionally or alternatively marked (or otherwise configured) to indicate any portions of the content (e.g., via the portion's start and end times) in which the speaker speaks. Additionally or alternatively, the particular portions of the content comprising spoken audio content from the speaker may be so-marked. Knowing the identity of the speaker, his or her voice profile may be readily retrieved or selected from a plurality of voice profiles. Additionally or alternatively, the voice profile associated with the speaker may be determined based on voice samples of the speaker reading a predetermined set of lines.

The voice profile may be updated on an on-going basis, in real-time, as the content is processed for audio correction. For example, each time a portion of the content is determined to comprise spoken audio content indicating one or more incorrect words (spoken by the speaker), the voice profile may be updated based on this spoken audio content and/or the one or more words indicated therein. Additionally or alternatively, the voice profile may be updated at other or additional intervals in the content. For example, the voice profile may be updated every 10 seconds (assuming the preceding 10-second interval comprising speech from the speaker). In this example, the voice profile may be updated based on any spoken audio content from the speaker during the preceding 10-second interval and/or any words indicated in the spoken audio content.

The voice profile may be determined via a feedback loop (e.g., the feedback loop 438 of FIG. 4). The feedback loop may provide feedback data relating to the voice profile properly representing the audio, vocal, and/or linguist characteristics of the speaker. The feedback data may further relate to the various audio correction processes that may use or be based on the voice profile, such as determining whether a word is incorrect or correct, determining a correct word to use in correcting an incorrect word, determining corrected spoken audio content (e.g., the second spoken audio content), and, by extension, determining the below-referenced second portion of content and determining the final corrected content. The voice profile may be additionally or alternatively referenced in determining the background audio content and performing ASR on the initial content to capture and translate any spoken audio content therein. As an example, a corrected output content determined by the method 500 (e.g., the output audio content 436 of FIG. 4) may be subject to manual or automated review, such as determining that corrected spoken audio content in the output content resembles the speaker's speech or that a correct word in corrected spoken audio is in fact a correction over the initial incorrect word. A determined voice profile may also be reviewed directly. The review data may be used to adjust the algorithm that determines a voice profile.

A machine learning algorithm (e.g., a machine learning model or other machine learning techniques) may be used to determine (e.g., update) a voice profile (e.g., the voice profile associated with the speaker in the first spoken audio content). The feedback loop may comprise the machine learning algorithm. The feedback loop may be trained generally with spoken audio content associated with a speaker (e.g., any spoken audio content in any content and associated with any speaker). The feedback loop may additionally or alternatively comprise a real-time feedback loop trained using the first spoken audio content and/or other spoken audio content in other portions of the content that is associated with the speaker. In the case of a machine learning algorithm, which may be determined based on training data, an input component of training data may comprise spoken audio content associated with a speaker and a corresponding output component of the training data may comprise the determined (e.g., by the machine learning algorithm) voice profile associated with the speaker. The output component of the training data may additionally or alternatively include performance metrics associated with the determined voice profile, such as whether the voice profile is an accurate representation of the speaker's speech and/or whether the transitions in the corrected output content between corrected spoken audio content determined based on the voice profile and original spoken audio content are smooth and most likely inconspicuous to viewers.

Feedback loops and/or machine learning algorithms may also be used with respect to other functions of the audio correction. For example, a feedback loop and/or machine learning algorithm may be determined to improve the process of determining that a word is incorrect and/or the process of determining a correct word associated with a particular incorrect word. A feedback loop and/or machine learning algorithm configured for determining that a word is incorrect may be trained generally based on spoken audio content, which may be further translated to text via ASR. Training data to determine such a machine learning algorithm may comprise the input spoken audio content as the training data input and the determined incorrect word (if any) as the training data output. The training data output may additionally or alternatively comprise an indication of whether the determine incorrect word is in fact incorrect and/or whether the machine learning algorithm failed to identify an incorrect word in a portion of content.

A feedback loop and/or machine learning algorithm configured for determining a correct word may be trained generally based on an input incorrect word (e.g., the incorrect word that is to be corrected using the determine correct word). Training data to determine such a machine learning algorithm may comprise the input incorrect word as the training data input and the determined correct word may comprise the training data output. The training data output may additionally or alternatively comprise an indication of whether the determined correct word is in fact an appropriate correction for the incorrect word.

A feedback loop and/or machine learning algorithm may be used to improve BSS techniques used to determine the background audio content. Such feedback loop and/or machine learning algorithm may effectively learn the various characteristics of the speaker's speech. The feedback loop and/or machine learning algorithm may be configured to determine the various separate signals/sources (background audio content, spoken audio content, etc.) in audio content. Training data to determine such a machine learning algorithm may comprise audio content (comprising background audio content and spoken audio content) as a training data input. BSS techniques may be based on a voice profile associated with a speaker in the audio content and, thus, the training data input may additionally or alternatively include such voice profile. A training data output of the training data may comprise the separated signals/sources that result from the BSS, including the determined background audio content. A training data output of the training data may additionally or alternatively comprise a qualitative metric indicating how well the constituent signals/sources were separated and isolated from one another. A training data output of the training data may additionally or alternatively comprise the corrected output content with spoken audio content indicating one or more corrected words. A training data output of the training data may additionally or alternatively comprise a qualitative metric relating to the correction in the output content (e.g., to what degree the corrected portion of the output content was consistent with adjacent portions of the output content, to what degree the generated speech in the corrected portion of the output content resembled that of the speaker, etc.).

At step 508, based on the voice profile, second spoken audio content (e.g., the corrected spoken audio content 430 of FIG. 4) is generated. The second spoken audio content indicates second one or more words to replace the first one or more words in the corrected content (e.g., the output audio content 436 of FIG. 4). The second one or more words may comprise at least one correct word that is associated with (e.g., corrects) at least one incorrect word in the first one or more words. As noted, the second one or more words may represent a correction over the first one or more words with respect to meaning, pronunciation, and/or grammar. The at least one correct word may be determined via machine learning techniques. For example, a machine learning model may be determined that is configured to receive an input of at least the incorrect word and output at least one associated correct word. The correct word may be a most-probable correct word. Additionally or alternatively, the correct word may be determined via rules- and/or dictionary-based techniques. A determination may be made as to whether to use the word determined via machine learning or the word determined via rules- and/or dictionary-based techniques as the final correct word. The correct word may be determined further based on the voice profile associated with the speaker. For example, knowledge of the speaker's vocal characteristics indicated in the voice profile may help to determine the word that the speaker meant to say rather than the incorrect word or the intended meaning that the speaker meant to convey with the incorrect word.

As the second spoken audio content is based on the voice profile associated with the speaker, the second spoken audio content may resemble the speaker's speech with respect to audio, vocal, and/or linguistic characteristics. The second spoken audio content may preferably resemble the speaker's speech to the extent that an average viewer would be unable to tell that the audio was altered. It is noted that spoken audio content shall be understood to encompass both human speech and computer-generated speech. Thus, although the second spoken audio content is per se computer-generated, it shall nonetheless be considered as being spoken, i.e., “spoken” audio content.

In the event that the second spoken audio content has a different duration than that of the first spoken audio content, the duration of the second spoken audio content may be expanded or contracted as needed to match that of the first spoken audio content. Based on any expansion or contraction of the second spoken audio content, the pitch of the second spoken content may be altered accordingly to minimize any negative effects that may be caused by the expansion or contraction.

At step 510, based on mixing (e.g., overlapping and/or adding) the background audio content and the second spoken audio content, a second portion of content is generated. The second portion of content may indicate the second one or more words, which comprises at least one correct word to replace or otherwise correct at least one incorrect word in the first one or more words. The second portion of content may comprise the second spoken audio content. The second portion of content may additionally or alternatively comprise the background audio content. In mixing the second spoken audio content and the background audio content, the second spoken audio content may occupy the portions of the audio spectrum occupied by any white noise or whitening effect in the background audio content or otherwise mask the white noise or whitening effect in the background audio content.

Additionally or alternatively, to correct the incorrect word(s) in the first portion of the content, mixing the second spoken audio content with the background audio content may comprise replacing the first spoken audio content (indicating one or more incorrect words) with the second spoken audio content (indicating one or more corresponding correct words). Mixing the second spoken audio content with the background audio content may comprise inserting an audio signal representing the second spoken audio content into the first portion of the content's audio spectrum to replace the audio signal that previously represented the first spoken audio content in the first portion of the content. In this example, the background audio content may remain as part of the first portion of the content (e.g., it is not separated out from the first portion of the content). In this example, step 512 may be omitted (which is not to be construed as step 512 otherwise being required to practice the techniques described herein) and the first portion of the content comprising the mixed second spoken audio content and the background audio content may be considered as (corrected) output content.

At step 512, the first portion of the content is replaced with the second portion of content determined in step 510. For example, the first portion of the content may be removed from the content and the second portion of content may be stitched into the content to take the first portion's place. The content (or portion thereof) comprising the second portion of content (e.g., the second spoken audio content indicating the second one or more (correct) words) may be considered as corrected output content (e.g., the output audio content 436 of FIG. 4).

In some instances, there may be several speakers (or other sources of spoken audio content), such as the aforementioned (first) speaker and a second speaker, conversing with one another or otherwise causing overlapping speech. It may be useful to additionally apply audio correction techniques to the second speaker's speech, if so required. In these or similar cases, the first portion of content determined in step 502 may further comprise third spoken audio content (said by the second speaker) indicating third one or more words. The third one or more words may comprise one or more words that should be replaced (e.g., incorrect words) or the third one or more words may include no words that should be replaced. The background audio content of the first portion of the content determined in step 504 may generally comprise at least part of the remainder of the first portion of the content minus the first spoken audio content and the third spoken audio content. Additionally or alternatively, the background audio content of the first portion of the content determined in step 504 may generally comprise the entirety of the remainder of the first portion of the content minus the first spoken audio content and the third spoken audio content. It is noted that the initial first portion of the content may also include other spoken audio content, except that it is treated as part of the background audio content and thus not designated for potential audio correction. For example, a sports broadcast may have an in-studio newscaster (first speaker; first spoken audio content), an on-site reporter at the sports event (second speaker; third spoken audio content), and a crowd of cheering fans (at least a portion of the background audio content). As the newscaster and the reporter are the featured speakers in the broadcast, it would be particularly useful for their speech to be corrected (e.g., with respect to meaning, pronunciation, and/or grammar), whereas the various cheers and shouts from the fans would be largely inconsequential (if it is even decipherable), and thus may be treated as part of the background audio content.

Continuing this example involving a second speaker, step 506 may further include determining a second voice based on the third spoken audio content. The second voice profile may be associated with the second speaker and generally representative of the various audio, vocal, and/or linguistic characteristics of the second speaker's speech. Step 508 may further include generating, based on the second voice profile, fourth spoken audio content indicating fourth one or more words to replace the third one or more words. The fourth one or more words may comprise correct words associated with the (incorrect) third one or more words. That is, the fourth one or more words are meant to correct the third one or more words with respect to meaning, pronunciation, and/or grammar. At step 510, generating the second portion may be further based on mixing the background audio content, the second spoken audio content, and the fourth spoken audio content.

In some cases there may be no overlap between the first spoken audio content and the third spoken audio content in the first portion of the content, while in other cases there may be at least some part(s) of the first portion of the content in which the first and third spoken audio content do overlap (e.g., the first and second speakers talk at the same time as one another at some point). In the former cases, mixing the background audio content, the second spoken audio content, and the fourth spoken audio content may include no direct mixing of the second spoken audio content and the fourth spoken audio content. In the latter cases, mixing the background audio content, the second spoken audio content, and the fourth spoken audio content may include at least some direct mixing of the second spoken audio content and the fourth spoken audio content. Step 512 may be performed in a generally similar manner as that described above, albeit the second portion of the content may include, at least in part, spoken audio content from the second speaker.

Additionally or alternatively, the background audio content of the first portion of the content may comprise or be divided into multiple channels of background audio content. The multiple channels may comprise respective signals and/or sources of background audio content. For example, the background audio content may comprise one channel for music (e.g., music played when cutting to and/or from a commercial) and another channel for ambient background noise at the filming location. The multiple channels may be determined via BSS.

Additionally or alternatively, the techniques described herein may be extended to correction of closed captioning. Auto-generated closed captioning, and even closed captioning transcribed by a human, may include incorrect words (e.g., words that may be useful to replace in output closed captioning). An incorrect word in closed captioning may be caused during transcription and/or derive from the speech itself (e.g., the speaker spoke a word with an unintended meaning, the speaker mispronounced a word, and/or spoken word(s) had a grammatical error). Content may be subject to both closed captioning correction and audio correction. For example, audio correction and closed captioning correction may be performed with respect to an item of content generally simultaneously and/or with one directly following the other.

In an implementation to additionally or alternatively correct closed captioning, input content may comprise closed captioning content, such as via a closed captioning channel, picture user data, a data stream, metadata, or other type of data associated with the input content. Closed captioning content may be in the form of text or in a digital format comprising closed captioning text. Closed captioning may comply with the CEA-708 standard. Closed captioning may include subtitles. Closed captioning content may include transcribed text of at least a portion of the corresponding audio content (e.g., the transcribed text of a featured speaker's speech). The transcribed text may be in the original language of the audio content or may be a translation of another language. Closed captioning content may include transcriptions of various sound effects or musical cues. Closed captioning content may include or otherwise convey (e.g., via additional text, special characters, and/or text's font, type, capitalization, etc.) contextual or supplemental information that may be useful for a viewer to better understand the auditory aspects of the content. For example, closed captioning content may include text that identifies a speaker, italicized text to indicate verbal emphasis of a word, capitalized text to indicate if dialogue is on-screen or off-screen, or musical note characters to indicate that words are sung.

Closed captioning correction may be similar in at least some respects to audio correction. Closed captioning correction may include receiving content comprising closed captioning content. The content may comprise audio content that is generally represented, at least in part, by the closed captioning content. The audio content may comprise spoken audio content associated with a speaker (or multiple speakers) and background audio content. The content may comprise video content over which the closed captioning may be overlaid during viewing. A first portion of the content comprising first closed captioning content indicating first one or more words may be determined. The first portion of the content may further comprise audio content, including spoken audio content from a speaker, and video content. The first one or more words indicated in the first closed captioning content may be associated with (representative of) the spoken audio content in the first portion of the content. The first one or more words may be words that are to be replaced in output content (e.g., incorrect words). An incorrect word in the context of closed captioning may be considered incorrect for similar reasons as in the context of spoken words. For example, an incorrect word may be considered incorrect with respect to meaning and/or grammar. An incorrect word in the context of closed captioning may be additionally considered incorrect with respect to spelling.

A voice profile associated with the speaker of the first one or more words may be determined. The voice profile may be generally representative of the speaker's speech. The voice profile may be determined in a similar manner as described with respect to audio correction. The voice profile may be determined based on the spoken audio content from the speaker and/or the first closed captioning content. For example, the voice profile may be determined based on audio, vocal, and/or linguistic characteristics of the speaker's speech. Although closed captioning content may not typically represent audio and/or vocal characteristics of a speaker's speech per se, various linguistic characteristics may be revealed by the first closed captioning content, such as preferences for certain words, speech patterns (e.g., patterns in sentence formation), or the speaker's local dialect or language variant.

The voice profile associated with the speaker may have been determined prior to determining the first portion of the content comprising the first closed captioning content indicating the first one or more words. For example, the voice profile may have been identified or marked in the content, such as via a manifest file or metadata. The voice profile may have been additionally or alternatively used in determining the first portion of the content comprising the first closed captioning content. For example, the voice profile may indicate that the speaker uses a particular local dialect or language variant in which a subject word has a certain spelling, yet the spelling of the word in the first one or more words is inconsistent with the speaker's dialect or language variant (e.g., “color” or “center” in American English versus “colour” or “centre” in Canadian English, respectively). Additionally or alternatively, the audio, vocal, and/or linguistic characteristics indicated in the speaker's profile may be used in determining the words actually spoken by the speaker in the first portion of the content. The words determined to have been spoken by the speaker may be compared against the first one or more words indicated in the first closed captioning content to identify any inconsistencies (e.g., incorrect words in the first closed captioning content).

Based on the voice profile, second closed captioning content may be generated. The second closed captioning content may indicate second one or more words to replace the first one or more words, for example, in corrected output content. The second one or more words may be correct words associated with the (incorrect) first one or more words. For example, referring to the dialect or language variant characteristic described above, the second one or more words may include word(s) that are respelled to be consistent with the dialect or language variant indicated in the voice profile. As another example, a spoken word in the corresponding spoken audio content in the first portion of the content may have been determined as being mispronounced and thus incorrectly misrepresented in the first one or more words. The second one or more words may include a correct word having the meaning intended by the mispronounced word.

The second closed captioning content may replace the first closed captioning content in the content. For example, the first closed captioning content may be removed or otherwise disassociated with the first portion of the content and the second closed captioning content may be inserted or otherwise caused to be associated with the first portion of the content.

Additionally or alternatively, based on the second closed captioning content, a second portion of content may be generated. The spoken audio content associated with the first part of the content may have also been corrected in addition to the closed captioning content. Generating the second portion of content may comprise mixing the corrected spoken audio content (indicating corrected word(s)) with the background audio of the first portion of the content, as well as replacing the (incorrect) first one or more words with the (correct) second one or more words. The determined second portion of content may replace the first portion of the content.

Additionally or alternatively, an example method relating to audio correction may comprise determining one or more incorrect spoken words in a portion of content. The one or more incorrect spoken words may comprise spoken audio content. Based on the one or more incorrect spoken words in the portion of the content, a voice profile may be determined. The voice profile may be associated with a speaker of the one or more incorrect spoken words. The voice profile may be determined via a real-time feedback loop trained with one or more spoken words associated with the speaker. Based on the voice profile, one or more correct spoken words may be generated to replace the one or more incorrect spoken words in the portion of the content. The one or more correct spoken words may comprise spoken audio content. The one or more incorrect spoken words may be removed from the portion of the content. To remove the one or more incorrect words from the portion of the content, the one or more incorrect spoken words may be replaced in the portion of the content by a whitening or white noise effect (e.g., via LPC). For example, the portions of the audio spectrum occupied by the one or more incorrect spoken words in the portion of the content may be replaced by the whitening or white noise effect. Additionally or alternatively, the one or more incorrect spoken words may be removed from the portion of the content by separating out the one or more incorrect spoken words (e.g., the audio signal or channel so-indicating) and background audio (e.g., the audio signal or channel so-indicating) from the portion of the content (e.g., via BSS). The one or more correct spoken words may be mixed with background audio in the portion of the content. The portion of the content comprising the mixed background audio and the one or more correct spoken words may be considered as corrected output content.

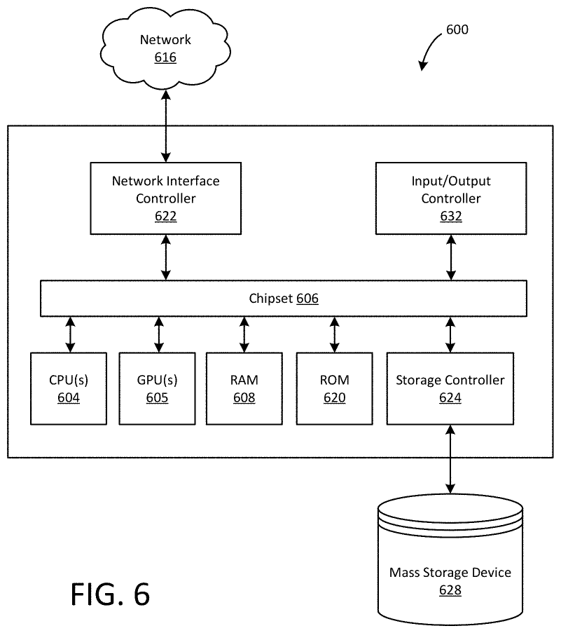

FIG. 6 shows an example computing device in which the systems, methods, and devices disclosed herein, or all or some aspects thereof, may be embodied. For example, components such as the video distribution system 102, the content source 108, the audio correction module 104, the voice profile module 106, or the client devices 114 of FIG. 1, as well as the various components of the system 400 of FIG. 4, may be implemented generally in a computing device, such as the computing device 600 of FIG. 6. The computing device of FIG. 6 may be all or part of a server, workstation, desktop computer, laptop, tablet, network appliance, PDA, e-reader, digital cellular phone, set top box, or the like, and may be utilized to implement any of the aspects of the systems, methods, and devices described herein.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical corrections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“ID-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described herein.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the systems, methods, and devices are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described systems, methods, and devices. When combinations, subsets, interactions, groups, etc., of these components are described, it is understood that while specific references to each of the various individual and collective combinations and permutations of these may not be explicitly described, each is specifically contemplated and described herein, for all systems, methods, and devices. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the systems, methods, and devices may take the form of an entirely hardware embodiment, an entirely software embodiment, or an embodiment combining software and hardware aspects. Furthermore, the systems, methods, and devices may take the form of a computer program product on a computer-readable storage medium having computer-readable program instructions (e.g., computer software) embodied in the storage medium. More particularly, the present systems, methods, and devices may take the form of web-implemented computer software. Any suitable computer-readable storage medium may be utilized including hard disks, CD-ROMs, optical storage devices, or magnetic storage devices.

Embodiments of the systems, methods, and devices are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate correction. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the systems, methods, and devices have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining a first portion of content comprising first spoken audio content indicating first one or more words;
determining background audio content of the first portion of the content;
generating second spoken audio content indicating second one or more words to replace the first one or more words;
generating, based on mixing the background audio content and the second spoken audio content, a second portion of content; and
replacing the first portion of the content with the second portion of content.

2. The method of claim 1, wherein the determining the background audio content comprises replacing, at least in part, the first spoken audio content in the first portion of the content with white noise.

3. The method of claim 1, wherein the determining the background audio content comprises separating out the background audio content from the first portion of the content.

4. The method of claim 1, further comprising:
determining, based on the first spoken audio content, a voice profile, wherein the generating the second spoken audio content is based on the voice profile.

5. The method of claim 4, wherein the voice profile indicates at least one of an audio characteristic, a vocal characteristic, or a linguistic characteristic.

6. The method of claim 4, wherein the voice profile is associated with a speaker of the first one or more words.

7. The method of claim 6, further comprising determining the voice profile via a feedback loop trained with spoken audio content associated with the speaker.

8. The method of claim 7, wherein the feedback loop comprises a real-time feedback loop and the spoken audio content used to train the feedback loop comprises spoken audio content of the content.

9. The method of claim 7, wherein the feedback loop comprises a machine learning algorithm.

10. The method of claim 4, wherein the first portion of the content further comprises first closed captioning content indicating first one or more words of closed captioning, the method further comprising:
generating, based on the voice profile, second closed captioning content indicating second one or more words of closed captioning to replace the first one or more words of closed captioning; and
causing the second one or more words of closed captioning to be associated with the second portion of content.

11. The method of claim 4, wherein the voice profile is associated with a first speaker of the first one or more words, and wherein the first portion of the content further comprises third spoken audio content indicating third one or more words spoken by a second speaker, the method further comprising:
determining, based on the third spoken audio content, a second voice profile associated with the second speaker; and
generating, based on the second voice profile, third spoken audio content indicating fourth one or more words to replace the third one or more words,
wherein the generating the second portion of content is further based on mixing the fourth spoken audio content with at least one of the background audio content or the second spoken audio content.

12. The method of claim 1, further comprising:
changing a duration of the second spoken audio content to correspond with a duration of the first spoken audio content; and
altering a pitch of the second spoken audio content based on the change in the duration of the second spoken audio content.

13. A method comprising:
determining a portion of content comprising background audio content and first spoken audio content indicating first one or more words;
removing the first spoken audio content from the portion of the content;
generating second spoken audio content indicating second one or more words associated with the first one or more words; and
mixing the second spoken audio content with the background audio content.

14. The method of claim 13, further comprising:
determining that the first one or more words comprise at least one incorrect spoken word to be replaced with at least one correct word in the second spoken audio content, wherein the at least one incorrect spoken word and the at least one correct word are respectively characterized as incorrect and correct with respect to one or more of meaning, pronunciation, or grammar.

15. The method of claim 13, wherein the removing the first spoken audio content from the portion of the content comprises applying a white noise effect to the first spoken audio content.

16. The method of claim 13, wherein the removing the first spoken audio content from the portion of the content comprises separating out the background audio content and the first spoken audio content from the portion of the content.

17. The method of claim 13, further comprising:
determining, based on the first spoken audio content, a voice profile, wherein the generating the second spoken audio content is based on the voice profile.

18. The method of claim 17, wherein the voice profile is associated with a speaker of the first one or more words.

19. The method of claim 18, further comprising determining the voice profile via a feedback loop trained with audio content associated with the speaker.

20. A method comprising:
determining first one or more spoken words in a portion of content;
generating second one or more spoken words to replace the first one or more spoken words in the portion of the content;
removing the first one or more spoken words from the portion of the content; and
mixing the second one or more spoken words with background audio in the portion of the content.

21. The method of claim 20, wherein:
the first one or more spoken words are characterized as being incorrect with respect to one or more of meaning, pronunciation, or grammar, and
the second one or more spoken words are characterized as being correct with respect to one or more of meaning, pronunciation, or grammar.

22. The method of claim 20, further comprising:
determining, based on the first one or more spoken words, a voice profile, wherein the generating the second one or more spoken words is based on the voice profile.

23. The method of claim 22, further comprising determining the voice profile via a real-time feedback loop trained with one or more spoken words in the content associated with a speaker of the first one or more spoken words.

24. The method of claim 20, wherein the removing the first one or more spoken words from the portion of the content comprises replacing, at least in part, the first one or more spoken words in the portion of the content with white noise.

25. The method of claim 20, wherein the removing the first one or more spoken words from the portion of the content comprises separating out the first one or more spoken words and the background audio from the portion of the content.
